(19) United States
(12) Patent Application Publication
(10) Pub. No.: US 2014/0336043 A1
(43) Pub. Date: Nov. 13, 2014

(54) COMPOSITE OXIDE, METHOD FOR PRODUCING THE SAME, AND CATALYST FOR EXHAUST GAS PURIFICATION

(71) Applicant: RHODIA OPERATIONS, Paris (FR)

(72) Inventors: Emmanuel Rohart, Shanghai (CN); Naotaka Ohtake, Anan-city (JP)

(21) Appl. No.: 14/366,625

(22) PCT Filed: Dec. 18, 2012
(86) PCT No.: PCT/EP2012/075908

§ 371 Date: Jun. 18, 2014

(30) Foreign Application Priority Data
Dec. 21, 2011 (JP) 2011-279119

(51) Int. Cl. B01J 23/10

(52) U.S. Cl. CPC B01J 23/10
USPC 502/250; 502/303; 502/304

(57) ABSTRACT

A composite oxide and a catalyst for purifying exhaust gas using the same are provided, which oxide has excellent heat resistance, including that a large specific surface area is maintained even when the composite oxide is used in a high temperature environment, and that, even after calcination at 800° C. for 2 hours, no AECeO₃ phase is detected and increase in CeO₂ crystallite size is inhibited. The composite oxide contains, in terms of oxides, 60 to 98 mass % of a cerium-containing element, the cerium-containing element consisting of Ce and at least one element selected from rare earth elements other than Ce and including Y, Zr, and Si at 85:15 to 100:0 by mass, 1 to 20 mass % of an alkaline earth metal element, and 1 to 20 mass % aluminum in terms of AI2O₃, wherein the composite oxide has properties of exhibiting a specific surface area of not smaller than 40 m²/g as measured by the BET method after calcination at 800° C. for 2 hours, and having no AECeO₃ phase and having a CeO₂ crystallite size in the (111) plane of not larger than 15 nm, as determined by X-ray diffraction after calcination at 800° C. for 2 hours.

### FIELD OF ART

The present invention relates to a composite oxide which may be used for catalysts, functional ceramics, solid electrolyte for fuel cells, abrasive, and the like, in particular, which may suitably be used as a co-catalyst material for catalysts for purifying vehicle exhaust gas, which reduces or eliminates NOx, and has excellent heat resistance. The present invention also relates to a method for producing the composite oxide, and a catalyst for purifying exhaust gas using the same.

### BACKGROUND ART

Internal combustion engines, such as vehicle engines, operate at a varying air-fuel (A/F) ratio in the combustion chamber, such as the stoichiometric (stoichiometric operation), fuel-rich compared to the stoichiometric (rich operation), or fuel-poor compared to the stoichiometric (lean operation). Lean burn engines and direct-injection engines have been put into practical use, which burn the fuel in a leaner atmosphere (excess-oxygen atmosphere) for the purpose of improving fuel efficiency in such internal combustion engines.

In such engines, however, conventional three-way catalysts cannot fully exhibit their NOx-elimination capacity in oxygen-excessive exhaust gas. In addition, emission limit of NOx in exhaust gases has recently become more and more strict, and effective elimination of NOx from exhaust gases even at high temperatures is demanded.

There is a method in current practice for eliminating NOx by adsorbing NOx by a NOx adsorber under lean conditions, and desorbing NOx from the NOx adsorber under stoichiometric conditions and reducing and discharging the desorbed NOx as N₂. However, the A/F ratio usually fluctuates and such reduction may not occur effectively, so that it is required to control the A/F ratio with an oxygen storage component to promote the reduction.

Usually, the NOx adsorber is predominantly a base material, such as an alkaline earth metal, typically a barium compound. On the other hand, the oxygen storage component is usually an oxide mainly of cerium.

As a NOx-eliminating catalyst having an oxygen adsorption-desorption effect, Patent Publication 1 proposes a catalyst composed of a compound of cerium and barium carrying a precious metal, such as Pt.

However, when such a catalyst is exposed to a temperature of as high as 800° C., a composite oxide BaCeO₃ is formed, which degrades the NOx adsorption capacity. Formation of BaCeO₃ also disadvantageously increases the CeO₂ crystallite size, decreases the specific surface area, which affects the oxygen adsorption, and causes sintering of the precious metal components, such as Pt. Consequently, the active sites for NOx-adsorption/reduction are reduced, and thus the NOx-eliminating capacity is deteriorated.

### PRIOR ART REFERENCES

### Patent Publication

Patent Publication 1: JP-2005-21878-A

### SUMMARY OF THE INVENTION

It is an object of the present invention to provide a composite oxide and a catalyst for purifying exhaust gas employing the composite oxide, which oxide has excellent heat resistance, including that a large specific surface area is maintained even when the composite oxide is used in a high temperature environment, and that, even after calcination at 800° C. for 2 hours, no AECeO₃ (AE stands for an alkaline earth metal element) phase, which deteriorates co-catalytic performance, is detected and increase in the CeO₂ crystallite size is inhibited, and which, in particular, is suitable as a co-catalyst of a catalyst for purifying exhaust gas.

It is another object of the present invention to provide a method for producing a composite oxide, which allows easy production of the above-mentioned composite oxide of the present invention with excellent heat resistance.

According to the present invention, there is provided a composite oxide comprising:

60 to 98 mass % of a cerium-containing element in terms of oxide, said cerium-containing element consisting of cerium and at least one element selected from the group consisting of rare earth metal elements other than cerium and including yttrium, zirconium, and silicon at 85:15 to 100:0 by mass in terms of oxides;

1 to 20 mass % of an alkaline earth metal element in terms of oxide; and

1 to 20 mass % of aluminum in terms of Al₂O₂,

wherein said composite oxide has properties of exhibiting a specific surface area of not smaller than 40 m²/g as measured by the BET method after calcination at 800° C. for 2 hours, and having no AECeO₂ phase and having a CeO₂ crystallite size in (111) plane of not larger than 15 nm, as determined by X-ray diffraction after calcination at 800° C. for 2 hours.

According to the present invention, there is provided a method for producing a composite oxide comprising the steps of:

(A) providing a cerium solution not less than 90 mole % of which cerium ions are tetravalent,

(B) heating and holding said cerium solution obtained from step (A) up to and at not lower than 60° C. to obtain a cerium suspension,

(C) adding at least precursors of an alkaline earth metal oxide and aluminum oxide to the cerium suspension obtained from step (B) to obtain a suspension,

(D) heating and holding said suspension obtained from step (C) up to and at not lower than 100° C.,

(E) adding a first precipitant to said suspension obtained from step (D) to precipitate elements other than said alkaline earth metal element,

(F) adding a second precipitant to obtain a precipitate containing said alkaline earth metal element, and

(G) calcining said precipitate obtained from step (F).

According to the present invention, there is also provided a catalyst for purifying exhaust gas comprising the composite oxide of the present invention.

The composite oxide according to the present invention contains cerium, an alkaline earth metal element, and aluminum at a particular ratio, has specific, excellent properties, and has excellent heat resistance, so that the present composite oxide is particularly useful as a co-catalyst for a catalyst for purifying exhaust gas. Since the composite oxide of the present invention has such properties, the active NOx adsorption sites are not decreased even when the oxide is exposed to high temperatures, so that a high NOx adsorption may be maintained under lean conditions. Further, an oxygen storage component, CeO₂, maintains a large specific surface area without being formed into an inactive compound AECeO₃, and is located close to the alkaline earth metal element, which is the NOx adsorption site, so that the present composite oxide is excellent in oxygen desorption capacity under rich conditions, and instantaneously turns the gas atmosphere to the stoichiometry to promote reduction of NOx.

The method for producing a composite oxide according to the present invention, including steps (A) to (G), allows easy production of composite oxides, including the composite oxide of the present invention.

### EMBODIMENTS OF THE INVENTION

The present invention will now be explained in more detail.

The composite oxide according to the present invention has a property of exhibiting a specific surface area of not smaller than 40 m²/g, preferably not smaller than 50 m²/g, more preferably not smaller than 60 m²/g, as measured by the BET method after calcination at 800° C. for 2 hours. The maximum of this specific surface area is not particularly limited, but about 120 m²/g. With the specific surface area of less than 40 m²/g as measured by the BET method after calcination at 800° C. for 2 hours, the active sites where NOx adsorption/desorption occur are decreased, and the NOx-elimination capacity is low.

Further, the composite oxide of the present invention has a property of exhibiting a specific surface area of preferably not smaller than 15 m²/g, more preferably not smaller than 20 m²/g, most preferably not smaller than 40 m²/g, as measured by the BET method after calcination at 900° C. for 2 hours. The maximum of this specific surface area is not particularly limited, but about 80 m²/g.

As used herein, the specific surface area is a value measured by the BET method employing nitrogen gas adsorption, which is the most standard technique for measuring the specific surface area of powders.

The composite oxide according to the present invention has properties of having no AECeO₃ phase and having the CeO₂ crystallite size in the (111) phase of not larger than 15 nm, preferably not larger than 13 nm, as determined by X-ray diffraction after calcination at 800° C. for 2 hours. It is particularly preferred that the composite oxide of the present invention has no AECeO₃ phase as determined by X-ray diffraction after calcination at 900° C. for 2 hours. With such properties, excellent heat resistance is maintained.

As used herein, “having no AECeO₃ phase ” means that no diffraction peak derived from AECeO₃ phase is observed by X-ray diffraction. For example, in the case of BaCeO₃ phase, this means that no peak is observed which interferes with the peak derived from CeO₂, and no peak is observed at 2θ=51°, where BaCeO₃ has high peak intensity.

The crystallite size in the (111) plane maybe calculated with the Scherrer equation from the peak near 2θ=28° of the X-ray diffraction spectrum determined by an X-ray diffractometer (MultiFlex manufactured by RIGAKU CORPORATION) using CuKα beam.

It is not known exactly why the composite oxide of the present invention has the properties excellent in heat resistance as mentioned above. However, it is assumed to be attributed to formation of an aluminum-containing layer on the surface of the cerium oxide particles, and subsequent adsorption of the alkaline earth metal element on the layer, so that direct contact between cerium and the alkaline earth metal element is inhibited, formation of AECeO₃ phase is inhibited even when the composite oxide is exposed to high temperatures, a large specific surface area is maintained, and increase in the crystallite size of CeO₂ is suppressed. The composite oxide of the present invention having such an estimated structure is assumed to have been obtained by, for example, the particular precipitation step in the production method of the present invention to be discussed later, wherein to a cerium suspension is added the other elements prior to precipitation, in particular, the step wherein the alkaline earth metal element is precipitated after the other elements.

The composite oxide according to the present invention has the properties discussed above, and contains 60 to 98 mass %, preferably 70 to 95 mass %, more preferably 80 to 90 mass % of a cerium-containing element in terms of oxides, 1 to 20 mass %, preferably 1 to 10 mass %, more preferably 1 to 5 mass % of an alkaline earth metal element in terms of oxide, and 1 to 20 mass %, preferably 5 to 18 mass %, more preferably 10 to 15 mass % of aluminum in terms of Al₂O₃.

The cerium-containing element is composed of cerium and at least one element selected from the group consisting of rare earth metal elements other than cerium and including yttrium (referred to as particular rare earthmetal elements hereinbelow) , zirconium, and silicon at 85:15 to 100:0 by mass in terms of oxides. When the cerium-containing element requisitely contains at least one element selected from the group consisting of the particular rare earth elements, zirconium, and silicon, the ratio of cerium to this element is preferably 85:15 to 95:5.

If the content of cerium in terms of oxide is less than 85 mass %, heat resistance may be low. If aluminum is not contained, sufficient heat resistance is not achieved. If the content of an alkaline earth metal element is over 20 mass% in terms of oxide, the specific surface area may be small.

The particular rare earth metal elements may be, for example, yttrium, lanthanum, praseodymium, neodymium, samarium, europium, gadolinium, terbium, dysprosium, holmium, erbium, thulium, ytterbium, lutetium, or a mixture of two or more of these. Among these, yttrium, lanthanum, praseodymium, neodymium, or a mixture of two or more of these is particularly preferred.

In the present invention, yttrium is expressed in terms of oxide as Y₂O₃, lanthanum as La₂O₃, cerium as CeO₂, praseodymium as Pr₆O₁₁, neodymium as Nd₂O₃, samarium as Sm₂O₃, europium as Eu₂O₃, gadolinium as Gd₂O₃, terbium as Tb₄O₇, dysprosium as Dy₂O₃, holmium as Ho₂O₃, erbium as Er₂O₃, thulium as Tm₂O₃, ytterbium. as Yb₂O₃, and lutetium as Lu₂O₃.

In the present invention, zirconium is expressed in terms of oxide as ZrO₂, silicon as SiO₂, an alkaline earth metal element, such as beryllium as BeO, magnesium as MgO, calcium as CaO, strontium as SrO, and barium as BaO.

As the alkaline earth metal element, when the composite oxide of the present invention is used in a catalyst for purifying exhaust gas, barium is preferred for fully exhibiting the performance of the catalyst.

The method according to the present invention, which allows easy and reproducible production of the composite oxide of the present invention, includes first step (A) of providing a cerium solution not less than 90 mole % of which cerium ions are tetravalent.

A water-soluble cerium compound used in step (A) may be, for example, a ceric nitrate solution or ammonium ceric nitrate, with the former being particularly preferred.

In step (A), the initial concentration of the cerium solution not less than 90 mole % of which cerium ions are tetravalent may be adjusted to usually 5 to 100 g/L, preferably 5 to 80 g/L, more preferably 10 to 70 g/L cerium in terms of CeO₂. For adjustment of concentration of the cerium solution, water is usually used, and deionized water is particularly preferred. At too high an initial concentration, crystallinity of the precipitate to be discussed later will not sufficiently be high, sufficient pores will not be formed, and the heat resistance of the eventually resulting composite oxide will be deteriorated. Too low an initial concentration lowers productivity and is not industrially advantageous.

In the method of the present invention, next, step (B) of heating and holding the cerium solution obtained from step (A) up to and at not lower than 60° C. to obtain a cerium suspension is performed. A reaction vessel used in step (B) may either be sealed or open type, and an autoclave reactor may preferably be used.

In step (B), the heating and holding temperature is not lower than 60° C., preferably 60 to 200° C., more preferably 80 to 180° C., most preferably 90 to 160° C. The heating and holding time is usually 10 minutes to 48 hours, preferably 30 minutes to 36 hours, more preferably 1 hour to 24 hours. Without sufficient heating and holding, crystallinity of the precipitate to be discussed later will not sufficiently be high, pores having sufficient volume will not be formed, and the heat resistance of the eventually resulting composite oxide may not be improved sufficiently. Too long heating and holding affect the heat resistance only little, and is not industrially advantageous.

The method of the present invention includes step (C) of adding at least precursors of an alkaline earth metal oxide and aluminum oxide to the cerium suspension obtained from step (B) to obtain a suspension.

When an oxide of at least one element selected from the group consisting of the particular rare earth metal elements, zirconium, and silicon, is to be contained in the eventually resulting composite oxide, a precursor of an oxide of at least one element selected from the group consisting of the particular rare earth metal elements, zirconium, and silicon may be added to the cerium suspension in step (C).

The precursor of an alkaline earth metal oxide may be, for example, a nitrate of an alkaline earth metal element. The precursor of aluminum oxide may be, for example, aluminum nitrate.

The precursor of an oxide of one of the particular rare earth metal elements may be any compound as long as it turns to an oxide of the particular rare earth metal element by oxidation treatment such as calcination, and may be, for example, a nitrate containing the particular rare earth metal element.

The precursor of zirconium oxide may be, for example, zirconium oxynitrate.

The precursor of silicon oxide may be any compound as long as it turns to silicon oxide by oxidation treatment such as calcination, and may be colloidal silica, siliconate, or a quaternary ammonium silicate sol, with colloidal silica being preferred in the light of production costs and reduction of environmental burden.

The amount of each precursor used in step (C) may suitably be decided so that the resulting oxide is within the content range in the composite oxide of the present invention.

Step (C) may be performed after the cerium suspension obtained from step (B) is cooled.

Such cooling may usually be carried out under stirring according to a commonly known method. Cooling in an atmosphere or forced cooling with cooling tubes may be employed. The cooling may be carried out down to usually 40° C. or lower, preferably about a room temperature of 20 to 30° C.

In step (C) , before adding the various precursors, the salt concentration of the cerium suspension may be adjusted by removing the mother liquor from the suspension or by adding water. The removal of the mother liquor may be effected, for example, by decantation, Nutsche method, centrifugation, or filter-pressing. In this case, a slight amount of cerium is removed with the mother liquor, so the amount of each precursor and water to be added next may be adjusted, taking this removed amount of cerium into consideration.

The method of the present invention includes step (D) of heating and holding the cerium suspension containing the various precursors up to and at not lower than 100° C., preferably 100 to 200° C., more preferably 100 to 150° C.

In step (D) , the duration of the heating and holding may be usually 10 minutes to 6 hours, preferably 20 minutes to 5 hours, more preferably 30 minutes to 4 hours.

Instep (D) of heating and holding, at lower than 100° C., the crystallinity of the precipitate to be discussed later will not sufficiently be high, resulting in insufficient heat resistance of the ultimate composite oxide. Too long a period of heating and holding affects little the heat resistance and is not industrially advantageous.

The method of the present invention includes step (E) of adding a first precipitant to the suspension obtained from step (D) to precipitate the elements other than the alkaline earth metal element.

The first precipitant used in step (E) may be a base, such as sodium hydroxide, potassium hydroxide, aqueous ammonia, ammonia gas, or a mixture thereof, with aqueous ammonia being particularly preferred. With such a first precipitant, the elements other than the alkaline earth metal element are precipitated as hydroxides.

The first precipitant may be added, for example, in the form of an aqueous solution at a suitable concentration to the suspension obtained from step (D) under stirring, or in the case of ammonia gas, by bubbling the suspension with the ammonia gas in the reactor under stirring. The amount of the precipitant to be added may easily be determined by monitoring the pH change of the suspension. Usually, the amount at which a precipitate is generated in the suspension at pH 7 to 9, preferably pH 7.5 to 8.5, is sufficient.

Step (E) maybe carried out after the cerium suspension obtained from step (D) is cooled. Such cooling may usually be carried out under stirring according to a commonly known method. Cooling in an atmosphere or forced cooling with cooling tubes may be employed. The cooling maybe carried out down to usually 40° C. or lower, preferably about a room temperature of 20 to 30° C.

The method of the present invention includes step (F) of adding a second precipitant to obtain a precipitate containing the alkaline earth metal element.

The second precipitant used in step (F) may be, for example, ammonium bicarbonate. With such a second precipitant, the alkaline earth metal element is precipitated as a carbonate.

The second precipitant may be added, for example, in the form of a powder, or an aqueous solution at a suitable concentration, to the suspension obtained from step (E) under stirring. The amount of the second precipitant to be added for obtaining a precipitate in the form of a carbonate may be in excess of twice the stoichiometric amount required for reacting the entire amount of the alkaline earth metal element into a carbonate, for complete reaction.

Through the precipitation reaction in step (F) , a slurry containing a precipitate of cerium oxide hydrate with grown crystals is obtained. The precipitate may be separated by, for example, the Nutsche method, centrifugation, or filter-pressing. The precipitate may optionally be washed with water as needed. Further, in order to improve the efficiency in the following step (G), the obtained precipitate may optionally be dried or calcined to a suitable extent.

Such calcination may preferably be carried out at usually 250 to 500° C., particularly 280 to 450° C., for usually 30 minutes to 36 hours, particularly 1 hour to 24 hours, more particularly 3 to 20 hours.

The method of the present invention includes step (G) of calcining the precipitate obtained from step (F). The temperature for the calcination is usually 300 to 700° C., preferably 350 to 600° C.

The duration of calcination in step (G) may suitably be decided in view of the calcination temperature, and may usually be 1 to 10 hours.

According to the method of the present invention, the composite oxide obtained from step (G) may be ground into powder before use. The grinding may be carried out with a commonly used pulverizer, such as a hammer mill, to sufficiently give a powder of a desired powder size.

The particle size of the composite oxide powder obtained by the present method may be made as desired through the above-mentioned grinding, and may preferably be a mean particle diameter of 1 to 50 μm for use as a co-catalyst for a catalyst for purifying exhaust gas.

The catalyst for purifying exhaust gas according to the present invention is not particularly limited as long as the catalyst is provided with a co-catalyst containing the composite oxide of the present invention. The method of production of the catalyst and other materials to be used therein may be, for example, conventional.

### EXAMPLES

The present invention will now be explained in more detail with reference to Examples and Comparative Examples, which are not intended to limit the present invention.

### Example 1

This example relates to a composite oxide of cerium, barium, and aluminum at 90:5:5 by mass in terms of oxides.

100 g in terms of CeO₂ of a ceric nitrate solution not less than 90 mole % of which cerium ions were tetravalent was measured out, and the total volume was adjusted to 2 L with pure water. The obtained solution was heated to 100° C. , held at this temperature for 30 minutes, and allowed to cool down to the room temperature, to thereby obtain a cerium suspension.

After the mother liquor was removed from the cerium suspension thus obtained, 8.9 g of barium nitrate (5.2 g in terms of BaO) and 38.6 g of aluminum nitrate (5.2 g in terms of Al₂O₃) were added, and the total volume was adjusted to 2 L with pure water.

Then the cerium suspension containing the precursors of barium oxide and aluminum oxide was held at 120° C. for 2 hours, allowed to cool, and neutralized to pH 8.5 with aqueous ammonia to confirm precipitation. Further, 10.8 g of ammonium bicarbonate was added, so that a precipitate was formed.

The obtained slurry was subjected to solid-liquid separation by Nutsche filtering to obtain a filter cake, which was calcined at 500° C. for 10 hours in the atmosphere to obtain a composite oxide powder. This composite oxide powder was subjected to quantitative analysis by ICP to determine its composition, which was cerium oxide, barium oxide, and aluminum oxide at 90:5:5 by mass.

The specific surface area of the composite oxide powder was measured by the BET method after calcination in the air at 800° C. for 2 hours, or in the alternative, at 900° C. for 2 hours. Further, the calcined composite oxide was subjected to X-ray diffraction at a tube voltage of 40 kV, tube current of 40 mA, scan speed of 1°/min., and sampling interval of 0.01°, to confirm the presence/absence of a BaCeO₃ phase. The CeO₂ crystallite size in the (111) plane of the calcined composite oxide was determined, using the Scherrer equation, from the half width of the peak of the X-ray diffraction pattern. The results are shown in Table 1.

### Example 2

This example relates to a composite oxide of cerium, barium, and aluminum at 85:10:5 by mass in terms of oxides. 100 g in terms of CeO₂ of a ceric nitrate solution not less than 90 mole % of which cerium ions were tetravalent was measured out, and the total volume was adjusted to 2 L with pure water. The obtained solution was heated to 100° C. , held at this temperature for 30 minutes, and allowed to cool down to the room temperature, to thereby obtain a cerium suspension.

After the mother liquor was removed from the cerium suspension thus obtained, 18.8 g of barium nitrate (11.0 g in terms of BaO) and 40. 8 g of aluminum nitrate nonahydrate (5.5 g in terms of Al₂O₃) were added, and the total volume was adjusted to 2 L with pure water.

Then the cerium suspension containing the precursors of barium oxide and aluminum oxide was held at 120° C. for 2 hours, allowed to cool, and neutralized to pH 8.5 with aqueous ammonia to confirm precipitation. Further, 22.8 g of ammonium bicarbonate was added, so that a precipitate was formed.

The obtained slurry was subjected to solid-liquid separation by Nutsche filtering to obtain a filter cake, which was calcined at 500° C. for 10 hours in the atmosphere to obtain a composite oxide powder. This composite oxide powder was subjected to quantitative analysis by ICP to determine its composition, which was cerium oxide, barium oxide, and aluminum oxide at 85:10:5 by mass.

The properties of the obtained composite oxide powder were evaluated in the same way as in Example 1. The results are shown in Table 1.

### Example 3

This example relates to a composite oxide of cerium, barium, and aluminum at 70:20:10 by mass in terms of oxides. 100 g in terms of CeO₂ of a ceric nitrate solution not less than 90 mole % of which cerium ions were tetravalent was measured out, and the total volume was adjusted to 2 L with pure water. The obtained solution was heated to 100° C. , held at this temperature for 30 minutes, and allowed to cool down to the room temperature, to thereby obtain a cerium suspension.

After the mother liquor was removed from the cerium suspension thus obtained, 45.7 g of barium nitrate (26.7 g in terms of BaO) and 99.5 g of aluminum nitrate nonahydrate (13.4 g in terms of Al₂O₃) were added, and the total volume was adjusted to 2 L with pure water.

Then the cerium suspension containing the precursors of barium oxide and aluminum oxide was held at 120° C. for 2 hours, allowed to cool, and neutralized to pH 8.5 with aqueous ammonia to confirm precipitation. Further, 55.5 g of ammonium bicarbonate was added, so that a precipitate was formed.

The obtained slurry was subjected to solid-liquid separation by Nutsche filtering to obtain a filter cake, which was calcined at 500° C. for 10 hours in the atmosphere to obtain a composite oxide powder. This composite oxide powder was subjected to quantitative analysis by ICP to determine its composition, which was cerium oxide, barium oxide, and aluminum oxide at 70:20:10 by mass.

The properties of the obtained composite oxide powder were evaluated in the same way as in Example 1. The results are shown in Table 1.

### Example 4

This example relates to a composite oxide of cerium, barium, and aluminum at 75:5:20 by mass in terms of oxides. 100 g in terms of CeO₂ of a ceric nitrate solution not less than 90 mole % of which cerium ions were tetravalent was measured out, and the total volume was adjusted to 2 L with pure water. The obtained solution was heated to 100° C. , held at this temperature for 30 minutes, and allowed to cool down to the room temperature, to thereby obtain a cerium suspension.

After the mother liquor was removed from the cerium suspension thus obtained, 10.6 g of barium nitrate (6.2 gin terms of BaO) and 185. 6 g of aluminum nitrate nonahydrate (25.0 gin terms of Al₂O₃) were added, and the total volume was adjusted to 2 L with pure water.

Then the cerium suspension containing the precursors of barium oxide and aluminum oxide was held at 120° C. for 2 hours, allowed to cool, and neutralized to pH 8.5 with aqueous ammonia to confirm precipitation. Further, 12.9 g of ammonium bicarbonate was added, so that a precipitate was formed.

The obtained slurry was subjected to solid-liquid separation by Nutsche filtering to obtain a filter cake, which was calcined at 500° C. for 10 hours in the atmosphere to obtain a composite oxide powder. This composite oxide powder was subjected to quantitative analysis by ICP to determine its composition, which was cerium oxide, barium oxide, and aluminum oxide at 75:5:20 by mass.

The properties of the obtained composite oxide powder were evaluated in the same way as in Example 1. The results are shown in Table 1.

### Example 5

This example relates to a composite oxide of cerium, zirconium, lanthanum, barium, and aluminum at 78:8:4:5:5 by mass in terms of oxides.

100 g in terms of CeO₂ of a ceric nitrate solution not less than 90 mole % of which cerium ions were tetravalent was measured out, and the total volume was adjusted to 2 L with pure water. The obtained solution was heated to 100° C. , held at this temperature for 30 minutes, and allowed to cool down to the room temperature, to thereby obtain a cerium suspension.

After the mother liquor was removed from the cerium suspension thus obtained, 32.4 ml of a zirconium oxynitrate solution (9.6 g in terms of ZrO₂), 15.8 ml of a lanthanum nitrate solution (4.8 g in terms of La₂O₃) , 10.3 g of barium nitrate (6.0 g in terms of BaO), and 44.5 g of aluminum nitrate nonahydrate (6.0 g in terms of Al₂O₃) were added, and the total volume was adjusted to 2 L with pure water.

Then the cerium suspension containing the precursors of zirconium oxide, lanthanum oxide, barium oxide, and aluminum oxide was held at 120° C. for 2 hours, allowed to cool, and neutralized to pH 8.5 with aqueous ammonia to confirm precipitation. Further, 12.5 g of ammonium bicarbonate was added, so that a precipitate was formed.

The obtained slurry was subjected to solid-liquid separation by Nutsche filtering to obtain a filter cake, which was calcined at 500° C. for 10 hours in the atmosphere to obtain a composite oxide powder. This composite oxide powder was subjected to quantitative analysis by ICP to determine its composition, which was cerium oxide, zirconium oxide, lanthanum oxide, barium oxide, and aluminum oxide at 78:8:4:5:5 by mass.

The properties of the obtained composite oxide powder were evaluated in the same way as in Example 1. The results are shown in Table 1.

### Example 6

This example relates to a composite oxide of cerium, yttrium, barium, and aluminum at 85:5:5:5 by mass in terms of oxides.

100 g in terms of CeO₂ of a ceric nitrate solution not less than 90 mole % of which cerium ions were tetravalent was measured out, and the total volume was adjusted to 2 L with pure water. The obtained solution was heated to 100° C. , held at this temperature for 30 minutes, and allowed to cool down to the room temperature, to thereby obtain a cerium suspension.

After the mother liquor was removed from the cerium suspension thus obtained, 22.0 ml of an yttrium nitrate solution (5.5 g in terms of Y₂O₃), 9.4 g of barium nitrate (5.5 g in terms of BaO), and 40.8 g of aluminum nitrate nonahydrate (5.5 g in terms of Al₂O₃) were added, and the total volume was adjusted to 2 L with pure water.

Then the cerium suspension containing the precursors of yttrium oxide, barium oxide, and aluminum oxide was held at 120° C. for 2 hours, allowed to cool, and neutralized to pH 8.5 with aqueous ammonia to confirm precipitation. Further, 11.5 g of ammonium bicarbonate was added, so that a precipitate was formed.

The obtained slurry was subjected to solid-liquid separation by Nutsche filtering to obtain a filter cake, which was calcined at 500° C. for 10 hours in the atmosphere to obtain a composite oxide powder. This composite oxide powder was subjected to quantitative analysis by ICP to determine its composition, which was cerium oxide, yttrium oxide, barium oxide, and aluminum oxide at 85:5:5:5 by mass .

The properties of the obtained composite oxide powder were evaluated in the same way as in Example 1. The results are shown in Table 1.

### Example 7

This example relates to a composite oxide of cerium, lanthanum, barium, and aluminum at 85:5:5:5 by mass in terms of oxides.

A composite oxide powder was prepared in the same way as in Example 6, except that the yttrium nitrate solution was replaced with 18.1 ml of a lanthanum nitrate solution (5.5 g in terms of La₂O₃). The obtained composite oxide powder was subjected to quantitative analysis by ICP to determine its composition, which was cerium oxide, lanthanum oxide, barium oxide, and aluminum oxide at 85:5:5:5 by mass.

The properties of the obtained composite oxide powder were evaluated in the same way as in Example 1. The results are shown in Table 1.

### Example 8

This example relates to a composite oxide of cerium, praseodymium, barium, and aluminum at 85:5:5:5 by mass in terms of oxides.

A composite oxide powder was prepared in the same way as in Example 6, except that the yttrium nitrate solution was replaced with 11.3 ml of a praseodymium nitrate solution (5.5 g in terms of Pr₆O₁₁). The obtained composite oxide powder was subjected to quantitative analysis by ICP to determine its composition, which was cerium oxide, praseodymium oxide, barium oxide, and aluminum oxide at 85:5:5:5 by mass.

The properties of the obtained composite oxide powder were evaluated in the same way as in Example 1. The results are shown in Table 1.

### Example 9

This example relates to a composite oxide of cerium, neodymium, barium, and aluminum at 85:5:5:5 by mass in terms of oxides.

A composite oxide powder was prepared in the same way as in Example 6, except that the yttrium nitrate solution was replaced with 21.4 ml of a neodymium nitrate solution (5.5 g in terms of Nd₂O₃). The obtained composite oxide powder was subjected to quantitative analysis by ICP to determine its composition, which was cerium oxide, neodymium oxide, barium oxide, and aluminum oxide at 85:5:5:5 by mass.

The properties of the obtained composite oxide powder were evaluated in the same way as in Example 1. The results are shown in Table 1.

### Example 10

This example relates to a composite oxide of cerium, barium, silicon, and aluminum at 80:10:5:5 by mass in terms of oxides.

100 g in terms of CeO₂ of a ceric nitrate solution not less than 90 mole % of which cerium ions were tetravalent was measured out, and the total volume was adjusted to 2 L with pure water. The obtained solution was heated to 100° C. , held at this temperature for 30 minutes, and allowed to cool down to the room temperature, to thereby obtain a cerium suspension.

After the mother liquor was removed from the cerium suspension thus obtained, 19.9 g of barium nitrate (11.7 g in terms of BaO) 28.5 g of colloidal silica (5.9 g in terms of SiO₂) , and 43.8 g of aluminum nitrate nonahydrate (5.9 g in terms of Al₂O₃) were added, and the total volume was adjusted to 2 L with pure water.

Then the cerium suspension containing the precursors of barium oxide, silicon oxide, and aluminum oxide was held at 120° C. for 2 hours, allowed to cool, and neutralized to pH 8.5 with aqueous ammonia to confirm precipitation. Further, 24.3 g of ammonium bicarbonate was added, so that a precipitate was formed.

The obtained slurry was subjected to solid-liquid separation by Nutsche filtering to obtain a filter cake, which was calcined at 500° C. for 10 hours in the atmosphere to obtain a composite oxide powder. This composite oxide powder was subjected to quantitative analysis by ICP to determine its composition, which was cerium oxide, barium oxide, silicon oxide, and aluminum oxide at 80:10:5:5 by mass.

The properties of the obtained composite oxide powder were evaluated in the same way as in Example 1. The results are shown in Table 1.

### Comparative Example 1

This example relates to a composite oxide of cerium and barium at 95:5 by mass in terms of oxides.

100 g in terms of CeO₂ of a ceric nitrate solution not less than 90 mole % of which cerium ions were tetravalent was measured out, and the total volume was adjusted to 2 L with pure water. The obtained solution was heated to 100° C. , held at this temperature for 30 minutes, and allowed to cool down to the room temperature, to thereby obtain a cerium suspension.

After the mother liquor was removed from the cerium suspension thus obtained, 8.4 g of barium nitrate (4.9 g in terms of BaO) was added, and the total volume was adjusted to 2 L with pure water.

Then the cerium suspension containing the precursor of barium oxide was held at 120° C. for 2 hours, allowed to cool, and neutralized to pH 8.5 with aqueous ammonia to confirm precipitation. Further, 10.2 g of ammonium bicarbonate was added, so that a precipitate was formed.

The obtained slurry was subjected to solid-liquid separation by Nutsche filtering to obtain a filter cake, which was calcined at 500° C. for 10 hours in the atmosphere to obtain a composite oxide powder. This composite oxide powder was subjected to quantitative analysis by ICP to determine its composition, which was cerium oxide and barium oxide at 95:5 by mass.

The properties of the obtained composite oxide powder were evaluated in the same way as in Example 1. The results are shown in Table 1.

### Comparative Example 2

This example relates to a composite oxide of cerium and barium at 90:10 by mass in terms of oxides.

100 g in terms of CeO₂ of a ceric nitrate solution not less than 90 mole % of which cerium ions were tetravalent was measured out, and the total volume was adjusted to 2 L with pure water. The obtained solution was heated to 100° C. , held at this temperature for 30 minutes, and allowed to cool down to the room temperature, to thereby obtain a cerium suspension.

After the mother liquor was removed from the cerium suspension thus obtained, 17.8 g of barium nitrate (10.4 g in terms of BaO) was added, and the total volume was adjusted to 2 L with pure water.

Then the cerium suspension containing the precursor of barium oxide was held at 120° C. for 2 hours, allowed to cool, and neutralized to pH 8.5 with aqueous ammonia to confirm precipitation. Further, 21.6 g of ammonium bicarbonate was added, so that a precipitate was formed.

The obtained slurry was subjected to solid-liquid separation by Nutsche filtering to obtain a composite oxide powder. This composite oxide powder was subjected to quantitative analysis by ICP to determine its composition, which was cerium oxide and barium oxide at 90:10 by mass.

The properties of the obtained composite oxide powder were evaluated in the same way as in Example 1. The results are shown in Table 1.

### Comparative Example 3

This example relates to a composite oxide of cerium, barium, and aluminum at 90:5:5 by mass in terms of oxides, synthesized by a method different from Example 1.

301.7 ml of a cerous nitrate solution (45 g in terms of CeO₂) , 4.3 g of barium nitrate (2.5 g in terms of BaO), and 18.4 g of aluminum nitrate nonahydrate (2.5 g in terms of Al₂O₃) were dissolved in pure water to give 500 ml of an aqueous solution.

This solution was added to an aqueous solution of a precipitant, i.e., 76.2 g of ammonium bicarbonate dissolved in pure water to bring the total volume to 500 ml, at room temperature over 30 minutes, with the pH maintained at 8.0 with aqueous ammonia, so that a precipitate was formed.

The obtained slurry was subjected to solid-liquid separation by Nutsche filtering to obtain a filter cake, which was calcined at 500° C. for 10 hours in the atmosphere to obtain a composite oxide powder. This composite oxide powder was subjected to quantitative analysis by ICP to determine its composition, which was cerium oxide, barium oxide, and aluminum oxide at 90:5:5 by mass.

The properties of the obtained composite oxide powder were evaluated in the same way as in Example 1. The results are shown in Table 1.

TABLE 1

| | | | | Formation of BaCeO₃ | |
|---|---|---|---|---|---|
| | Composition of composite | Specific surface | | phase/CeO₂ crystallite | |
| | oxide in terms of oxides | area (m²/g) | | size in the (111) plane (nm) | |
| | (mass %) | 800° C./2 h | 900° C./2 h | 800° C./2 h | 900° C./2 h |
| Ex. 1 | Ce/Ba/Al = 90/5/5 | 71 | 45 | NO/12 | NO/15 |
| Ex. 2 | Ce/Ba/Al = 85/10/5 | 62 | 20 | NO/13 | YES/25 |
| Ex. 3 | Ce/Ba/Al = 70/20/10 | 42 | 15 | NO/13 | YES/24 |
| Ex. 4 | Ce/Ba/Al = 75/5/20 | 81 | 42 | NO/10 | NO/14 |
| Ex. 5 | Ce/Zr/La/Ba/Al = 78/8/4/5/5 | 72 | 48 | NO/12 | NO/16 |
| Ex. 6 | Ce/Y/Ba/Al = 85/5/5/5 | 63 | 32 | NO/11 | NO/14 |
| Ex. 7 | Ce/La/Ba/Al = 85/5/5/5 | 68 | 38 | NO/12 | NO/17 |
| Ex. 8 | Ce/Pr/Ba/Al = 85/5/5/5 | 65 | 35 | NO/12 | NO/18 |
| Ex. 9 | Ce/Nd/Ba/Al = 85/5/5/5 | 70 | 34 | NO/12 | NO/15 |
| Ex. 10 | Ce/Ba/Si/Al = 80/10/5/5 | 86 | 53 | NO/12 | YES/20 |
| Comp. Ex. 1 | Ce/Ba = 95/5 | 17 | 8 | YES/52 | YES/79 |
| Comp. Ex. 2 | Ce/Ba = 90/10 | 15 | 8 | YES/56 | YES/82 |
| Comp. Ex. 3 | Ce/Ba/Al = 90/5/5 | 41 | 23 | NO/18 | NO/20 |

The results in Table 1 clearly show that in the composite oxides of the present invention, specific surface areas after calcination at 800° C. or higher were significantly improved, formation of a BaCeO₃ phase was prevented, and the CeO₂ crystallite size was kept small.

Further, with the production method of the present invention, the composite oxide having the above properties may be synthesized.

1. A composite oxide comprising:
60 to 98 mass % of a cerium-containing element in terms of oxide, said cerium-containing element consisting of cerium and at least one element selected from the group consisting of zirconium, silicon and rare earth metal elements other than cerium at 85:15 to 100:0 by mass in terms of oxides;
1 to 20 mass % of an alkaline earth metal element in terms of oxide; and
1 to 20 mass % of aluminum in terms of Al₂O₃;
wherein said composite oxide (i) exhibits a specific surface area of not smaller than 40 m²/g as measured by the BET method after calcination at 800° C. for 2 hours, (ii) has no AECeO₃ phase wherein AE is an alkaline earth metal element, and (iii) has a CeO₂ crystallite size in (111) plane of not larger than 15 nm, as determined by X-ray diffraction after calcination at 800° C. for 2 hours.

2. The composite oxide according to claim 1, wherein said alkaline earth metal element comprises barium.

3. The composite oxide according to claim 1, wherein said alkaline earth metal element is present in an amount of 1 to 15 mass % in terms of oxide.

4. The composite oxide according to claim 1, wherein said composite oxide exhibits a specific surface area of not smaller than 50 m²/g as measured by the BET method after calcination at 800° C. for 2 hours.

5. A method for producing a composite oxide comprising the steps of:
(A) providing a cerium solution not less than 90 mole % of which cerium ions are tetravalent,
(B) heating and holding said cerium solution obtained from step (A) up to and at not lower than 60° C. to obtain a cerium suspension,
(C) adding at least precursors of an alkaline earth metal oxide and aluminum oxide to said cerium suspension obtained from step (B) to obtain a suspension,
(D) heating and holding said suspension obtained from step (C) up to and at not lower than 100° C.,
(E) adding a first precipitant to said suspension obtained from step (D) to precipitate elements other than said alkaline earth metal element,
(F) adding a second precipitant to obtain a precipitate containing said alkaline earth metal element, and
(G) calcining said precipitate obtained from step (F).

6. The method according to claim 5, wherein in step (C), a precursor of an oxide of at least one element selected from the group consisting of zirconium, silicon and rare earth metal elements other than cerium is further added to said cerium suspension obtained from step (B).

7. The method according to claim 5, wherein said precursor of an alkaline earth metal oxide comprises a precursor of barium oxide.

8. A catalyst for purifying exhaust gas comprising the composite oxide of claim 1.

9. The composite oxide of claim 1, wherein the composite oxide comprises:
60 to 98 mass % of a cerium-containing element in terms of oxide, said cerium-containing element consisting of cerium and at least one element selected from the group consisting of zirconium, silicon and rare earth metal elements other than cerium at 85:15 to 100:0 by mass in terms of oxides;
1 to 15 mass % of an alkaline earth metal element in terms of oxide; and
1 to 20 mass % of aluminum in terms of Al₂O₃;
and wherein said composite oxide (i) exhibits a specific surface area of not smaller than 50 m²/g as measured by the BET method after calcination at 800° C. for 2 hours, (ii) has no AECeO₃ phase wherein AE is an alkaline earth metal element, and (iii) has a CeO₂ crystallite size in (111) plane of not larger than 15 nm, as determined by X-ray diffraction after calcination at 800° C. for 2 hours.

10. The composite oxide according to claim 9, wherein said alkaline earth metal element comprises barium.

11. The composite oxide according to claim 9, wherein said cerium-containing element is present in an amount of 70 to 95 mass % in terms of oxide

12. The composite oxide according to claim 11, wherein said cerium-containing element is present in an amount of 80 to 90 mass % in terms of oxide.

13. The composite oxide according to claim 9, wherein said alkaline earth metal element is present in an amount of 1 to 10 mass % in terms of oxide.

14. The composite oxide according to claim 13, wherein said alkaline earth metal element is present in an amount of 1 to 5 mass % in terms of oxide.

15. The composite oxide according to claim 9, wherein said aluminum is present in an amount of 5 to 18 mass % in terms of Al₂O₃.

16. The composite oxide according to claim 15, wherein said aluminum is present in an amount of 10 to 15 mass % in terms of Al₂O₃.

17. The composite oxide according to claim 9, wherein said rare earth metal element comprises yttrium, lanthanum, praseodymium, neodymium, samarium, europium, gadolinium, terbium, dysprosium, holmium, erbium, thulium, ytterbium, lutetium, or mixtures thereof

18. A catalyst for purifying exhaust gas comprising the composite oxide of claim 9.
